(19) United States
(12) Patent Application Publication
(10) Pub. No.: US 2025/0263574 A1
(43) Pub. Date: Aug. 21, 2025

(54) ANTI-LIGATURE DOOR HANDLE

(71) Applicant: Sargent Manufacturing Company, New Haven, CT (US)

(72) Inventor: Daniel W. Riley, Meriden, CT (US)

(73) Assignee: Sargent Manufacturing Company, New Haven, CT (US)

(21) Appl. No.: 19/054,082

(22) Filed: Feb. 14, 2025

Related U.S. Application Data
(60) Provisional application No. 63/555,561, filed on Feb. 20, 2024.

(51) Int. Cl. C09D 127/18; B29C 63/00; B29C 63/02; B29C 67/04; B29K 27/18; B29K 105/04; B29L 31/46; E05B 1/00

(52) U.S. Cl. CPC C09D 127/18; B29C 63/0017; B29C 63/0073; B29C 63/02; B29C 67/04; E05B 1/003; B29K 2027/18; B29K 2105/041; B29K 2995/003; B29K 2995/0073; B29K 2995/0077; B29L 2031/463

(57) ABSTRACT

An anti-ligature door handle is disclosed. The door handle assembly includes a handle, an escutcheon, and a PTFE coating. The door handle assembly is constructed in a manner where a cord or rope cannot readily be anchored to any surface. This is due to the sloping geometry of the door handle assembly along with the low friction coating. The low friction coating may be a sintered and skived sheet of PTFE or a sprayed layer of PTFE that ensures sufficient strength, resilience, and friction properties when applied.

### CROSS-REFERENCE TO RELATED APPLICATIONS

This application claims the benefit under 35 U.S.C. § 119(e) of U.S. Provisional Application Ser. No. 63/555,561, entitled “ANTI-LIGATURE DOOR HANDLE” and filed Feb. 20, 2024, which is incorporated herein in its entirety.

Disclosed embodiments are related to an anti-ligature door handle coated with Polytetrafluoroethylene (PTFE).

### BACKGROUND

In environments where people pose a threat to themselves, anti-ligature handles have been used to ensure that patients cannot use them as an anchor point of a noose.

### SUMMARY

According to one aspect, an anti-ligature door handle assembly is disclosed. The anti-ligature door handle assembly includes a handle having a handle surface, and an escutcheon disposed at the base of the handle, the escutcheon having an escutcheon surface. A polytetrafluoroethylene (PTFE) coating is disposed on at least a portion of the handle surface and at least a portion of the escutcheon surface.

According to another aspect, a method for coating an anti-ligature door handle assembly is disclosed. The method includes sintering polytetrafluoroethylene (PTFE) particles to create a bulk volume of PTFE; skiving the bulk volume of PTFE to obtain a PTFE sheet of consistent thickness; and coating an anti-ligature handle with the PTFE sheet.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein. In the drawings:

FIG. 1 shows a top, front perspective view of a door handle assembly disposed on a door;

FIG. 2 illustrates a cross-sectional view showing the handle escutcheon and the coating;

FIG. 3 shows a top, front, right perspective view of the handle;

FIG. 4 shows a top, front, right perspective view of the escutcheon;

FIG. 5 shows a manufacturing process of the PTFE coating; and

FIG. 6 shows a coating process for the door handle assembly.

### DETAILED DESCRIPTION

Anti-ligature door handles are designed to have no surface which slopes towards the escutcheon. In other words, the distal portion of the top surface of the handle must remain lower than the proximal portion of the handle, and the distal portion of the bottom surface must remail higher than the proximal portion of the handle. This is designed such that a rope or cord cannot be hung from the door handle, and if this is attempted, the rope or cord would simply slide off. Additionally, some anti-ligature door handles exist where a portion of a movable handle extends in a generally parallel construction, but when a force is applied to the handle, the handle pivots, and a noose would slide off.

Additionally, friction may influence an anti-ligature handle's effectiveness other than the geometry of the handle. For example, if the coefficient of friction is too high, when a force is applied to the rope or cord, the frictional force may be too high on the sloped handle surface, causing the cord to remain on the door handle rendering the anti-ligature properties ineffective. Thus, even though the geometry of the handle may be appropriate for an anti-ligature device, it may not function as intended.

Historically, materials such as polished steel or Acrylonitrile Butadiene Styrene (ABS) plastics have been used in order to decrease the coefficient of friction present on the surface of the handle. However, both of these materials have distinct weaknesses. These handles must have a very low coefficient of friction while also being resilient enough to withstand repetitive harsh forces, chemical cleanings, and UV light cleanings. Although polished steel is robust and can withstand repetitive cleaning cycles, the coefficient of friction is much higher than plastic alternatives. This is especially true once the surface is old, and use has made the surface less polished. ABS plastic also has its own set of disadvantages. Specifically, when exposed to UV light or other cleaning mechanisms, the plastic coating can degrade and begin to flake. This results in a surface with a higher coefficient of friction which negates the intended performance of the device.

The Inventors have discovered that applying a low friction coating to a door handle assembly is advantageous to create an anti-ligature handle. The handle coating is designed to maintain a low coefficient of friction value through intense and repetitive use and cleaning. This coating may be exposed to repeated UV, chemical, and other forms of cleaning without deteriorating. This handle coating may also be exposed to repeated use and abrasion without deteriorating. These features allow the handle coating to have a longer lifetime of use where the handle coating remains highly functional (e.g., an acceptable coefficient of friction and an acceptable level of physical integrity) during the entirety of this lifetime. One aspect disclosed herein relates to an anti-ligature door handle assembly having a PTFE coating.

Although the geometry of an anti-ligature door handle assembly is designed in a manner which reduces or eliminates components that can grasp a cord, sloping surfaces with high friction coefficients can still be used as an anchoring point for the cord. Accordingly, in one aspect disclosed herein, a PTFE coating may be applied to at least the surfaces which could otherwise anchor a cord. These surfaces may contain but are not limited to the lever or nob, and the escutcheon. The PTFE coating may also be applied to all surfaces in order to assist in durability along with the case of manufacturing.

Most traditional anti-ligature door handle assemblies are constructed of polished stainless steel, or ABS plastic. Polished stainless steel has a coefficient of friction between 0.5 and 0.6. ABS plastic has a coefficient of friction between 0.35 and 0.45. The inventor's discovery of using PTFE as an effective anti-ligature coating is due to its low coefficient of friction. PTFE has a coefficient of friction between 0.05 and 0.1. This value is lower than the other conventional materials used in anti-ligature applications. The use of PTFE may also result in a wider breadth of geometries available to the door handle assembly designer in that the geometry may play a lesser role in an anti-ligature door latch assembly having its components coated with a low-friction material such as PTFE.

With a much lower coefficient of friction, the handle may be designed in a way which has much less extreme slopes. Some benefits of less extreme slopes may include, but is not limited, to increasing the usability of the door handle assembly. Door handles with surfaces which protrude more and are more horizontal are easier to operate. These designs are only possible in an anti-ligature door handle assembly when the surface has a very low coefficient of friction.

A PTFE coating also provides a surface that can be more readily cleaned. PTFE on a surface reflects light and, without wishing to be bound by theory, does so in a nearly Lambertian manner. In many hospital or institutional settings, cleaning is performed with ultraviolet germicidal irradiation (UVGI). A door handle assembly that is coated with PTFE can therefore be subject to UVGI without compromising the underlying material. For example, UVGI cleaning is not compatible with many plastics including a variety of ABS plastics. When UV light is exposed to an unsuitable plastic, it breaks down bonds in the polymer chains which provide the structure of the plastic. This makes the plastic more rigid and leads to disintegration. Therefore, the inventor has found that coating a door handle assembly with PTFE will allow for UVGI cleaning without subjecting the material to light that may result in decomposition of the components of the door handle assembly. In addition to being able to withstand UVC without degradation of material, the reflectivity of the material increases the cumulative irradiation of anything on top of the PTFE coating. This decreases the time required to eliminate a desired percentage of virus/germ/bacteria. Therefore, exposing UV light to a PTFE surface will eliminate more contaminants than exposing a metal surface to UV light for the same duration of time.

The PTFE coating can be applied to the door handle assembly in any suitable manner as the disclosure is not limited in this respect. However, the inventors have found that variations in certain performance characteristics (e.g., friction and pore size and/or thickness) can have negative implications with respect to an anti-ligature product. For example, an inconsistently applied coating could cause a rope or a cord to snare onto the door handle assembly and defeat the anti-ligature desirability. According to some aspects, the inventor has found that applying a PTFE coating so as to result in a consistent thickness and consistent characteristics, including low friction characteristics, the door handle assembly is coated by layering PTFE sheets onto all exposed surfaces. Sheets are produced by first sintering PTFE particles, where the particles are fused together using heat and pressure to produce a cohesive porous solid. This technique allows for precise control of the output material properties including pore size and pore volume.

The inventors have also identified that other methods of coating provide sufficient material properties while also providing more cost-effective utilization than sintered and skived PTFE. An example of this is sprayed PTFE. Although the thickness may be less consistent, similar pore size and abrasion resistance is present in sprayed PTFE when compared to sintered and skived PTFE. Spray coating may be easier to apply to the non-uniform surfaces associated with a door handle. As mentioned above, grooves and ridges which may interfere with the low friction qualities of the anti-ligature door handle should be avoided. Accordingly, a sprayed PTFE application, which may readily create seamless coatings, may be desirable.

In one embodiment, in order to ensure that the geometry of the door handle assembly is preserved when coated with PTFE, the PTFE surface is skived. This ensures a consistent, and thin coating of PTFE which allows for the original geometry of the door handle assembly to be remain, even after it has been coated. As mentioned earlier, the geometry of the door handle assembly should have surfaces that slope in a manner to cause a rope or cord to slip. Unevenness in the coating may disrupt this geometry. However, sprayed PTFE may still provide approximately uniform thickness sufficient to conserve the general geometry of the door handle assembly.

The skiving may also allow for a consistent optimal thickness to be achieved. In one embodiment, the PTFE may be manufactured with a large thickness that must be reduced in size for the desired application. In one embodiment, the coating is skived from a thick layer to a sheet having a thickness of about 0.75 mm. When applied thereafter to the door handle assembly, all portions thereof have the desired thickness that is required for optimal strength and form. The inventors have found that if skiving were not performed and a coating was applied directly to the door handle assembly so as to have a thickness of 0.75 mm as the goal, there likely would be inconsistencies resulting in PTFE thicknesses both above and below the goal value. This would result in unfavorable characteristics including but not limited to fragility, susceptibility to scratching, bulging surfaces, and possible weak points in the coating. However, sprayed PTFE may result in approximately uniform surfaces which mitigates these possible weaknesses while still having relatively efficient application process.

Sintered and skived PTFE, and sprayed PTFE material offers many benefits over traditional forms of extended PTFE coating. The advantages include but are not limited to low flex fatigue, omnidirectional diffuse reflectance and compatibility with heat and vibrational welding. This results in a material which possesses high omni-directional tensile strength. In an anti-ligature door handle assembly, the surface is under physical strain and must be relatively thin. Accordingly, it may be beneficial for the coating material to be resilient to abrasions and forces while still being thin. As mentioned above, sintered and skived PTFE, and sprayed PTFE provide these properties.

Testing also shows that PTFE samples that have been sintered and skived or sprayed exhibit lower and more consistent medium pore diameter (roughly 1 to 7 micrometers) than those that were sintered and molded (roughly 7 to 27 micrometers). The consistent and small pore structure increase strength due to the uniformity of the resulting structure. That is weak points in the resulting structure may be avoided or reduced. Other forms of PTFE, such as extended PTFE (ePTFE), may be too fragile and may require a supporting layer due to its low strength.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

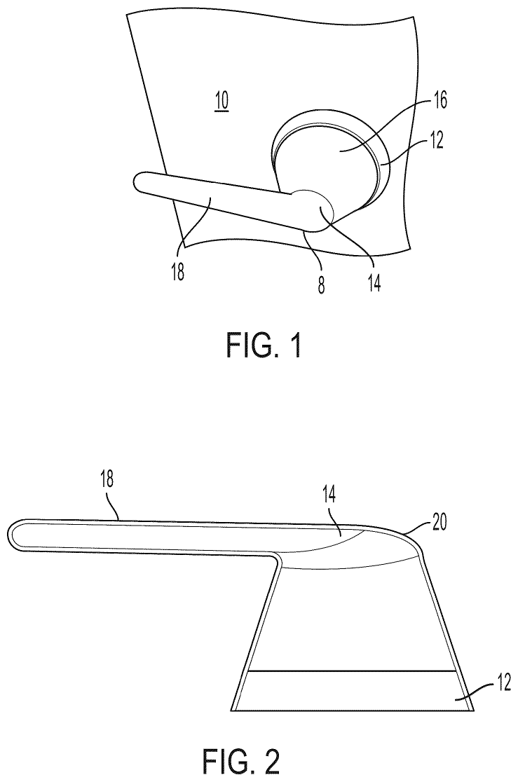

FIG. 1 shows the exterior structure of the door handle assembly 8 attached to a door 10. The door handle assembly 8 includes an escutcheon 12 and a door handle 14. The door handle 14 is rotatable relative to the escutcheon 12. In this embodiment, the door handle 14 includes a handle extension 16 adjacent the escutcheon 12 and a lever portion 18. The lever portion 18 is generally parallel with the ground when not in operation. The door handle extension 16, the lever portion 18 and the escutcheon 12 have sufficiently sloped surfaces such that they are also unable to support a ligature. Further, any force from a ligature on the lever portion 18 will cause the handle portion to rotate.

As described above, the door handle assembly includes a PTFE coating on all exterior surfaces, including the exterior surfaces of the escutcheon and the lever portion. FIG. 2 illustrates a cross-sectional view showing the PTFE coating 20 on all exterior surfaces of the handle assembly. However, the inventors acknowledge that in some embodiments only portions of the door handle assembly may be coated in PTFE. In this regard, only those surfaces that can otherwise support or hold a ligature are covered with a PTFE coating. Other surfaces that are not or would not be exposed to a ligature need not be covered with the PTFE coating. In this respect, as discussed above, the PTFE coating reduces the coefficient of friction present on the surface of the handle assembly. This in combination with the geometry of the handle seen in FIG. 1 acts to reduce the likelihood of the handle assembly being an anchor point for a ligature.

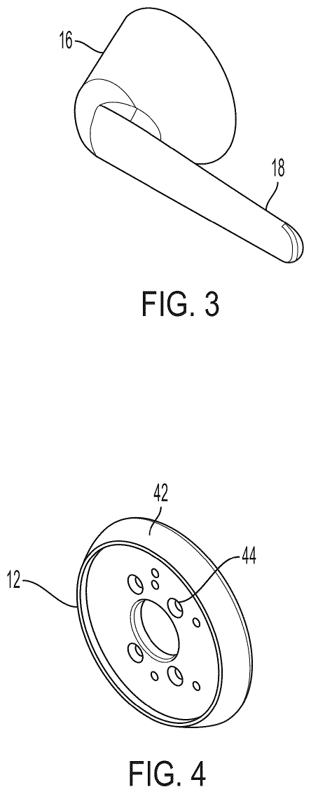

FIG. 3 is a perspective view of the door handle 10. It should be noted that this figure does not depict the escutcheon 12. The entire structure seen in FIG. 3 rotates when a downward force is applied to the lever portion of the handle 18. The handle extension 16 is fixed to the lever portion of the handle 18, and these portions rotate together when the door handle is used. Door handle extension 16 is tapered, as shown in FIGS. 1-3.

It should also be appreciated that FIG. 3 does not directly show the inclusion of the PTFE coating. However, it should be noted that the handle would be at least partially covered in the PTFE coating. Additionally, it should be noted that the these features reduce the risk that the door handle assembly can support weight from a ligature and instead the rope or cord would simply slide off.

FIG. 4 shows the overall structure of the escutcheon 12. This is the physical structure which cooperates with the door handle and completes the door handle assembly in some embodiments. The escutcheon may also have the PTFE coating covering at least a portion of the surfaces. The placement of PTFE coating may rely on the geometry of the escutcheon along with the location in which it is installed but is limited to locations on the exterior surface 42. The holes 44 are used to attach the escutcheon to the door latch (not shown).

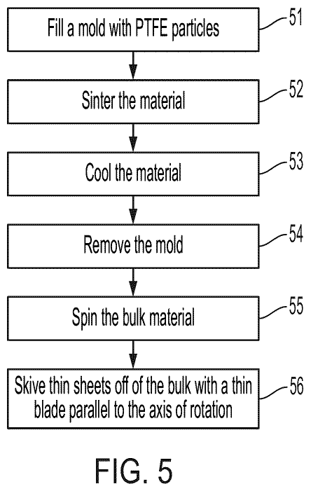

FIG. 5 depicts one embodiment of the process for manufacturing a sintered and skived PTFE coating. As shown, and without wishing to be bound by theory, the process allows for the coating to have properties which are beneficial to anti-ligature door handle assemblies. At box 51, a mold is filled with PTFE particles. At box 52, heat and pressure are applied, sintering the small particles into a bulk solid. At box 53, when cooled, the mold is removed at box 54. At box 55, the bulk material is spun. A sharp blade is positioned such that when the bulk material is spun, thin sheets are peeled from the bulk in a process known as skiving as at box 56. When the thin sheets are separated from the bulk, they are cut into sections ready to be applied to the door handle assembly.

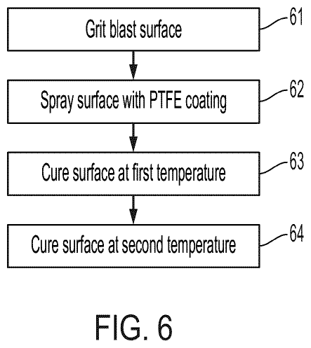

FIG. 6 depicts an embodiment of a process for coating the door handle assembly with PTFE. This process involves spray coating and oven curing. As shown, and without wishing to be bound by theory, the process allows for the coating to have properties which are beneficial to anti-ligature door handle assemblies and allows for the PTFE to easily coat the handle assembly. At box 61, the door handle surface is grit blasted where PTFE is desired in order to assist PTFE adhesion. At box 62, PTFE is sprayed onto the desired surface at a thickness between 0.0006 and 0.0008 in. At box 63, the surface is oven cured at a first temperature of approximately 400 F for approximately 4 minutes in order to dry solvents in the PTFE. At box 64, the surface is oven cured at a second temperature of approximately 750 F for approximately 5 minutes in order to cure the PTFE coating.

Both sintered and skived PTFE and sprayed PTFE materials offers many benefits over forms of extended PTFE coating. The advantages include but are not limited to low flex fatigue, omnidirectional diffuse reflectance and compatibility with heat and vibrational welding. This results in a material which possesses high omni-directional tensile strength. In an anti-ligature door handle assembly, the surface is under constant physical strain and must be relatively thin. Accordingly, it is highly beneficial for the coating material to be resilient to abrasions and forces while still being thin. As mentioned above, sintered and skived PTFE and sprayed PTFE have these beneficial properties.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An anti-ligature door handle assembly, comprising;
a handle having a handle surface;
an escutcheon disposed at a base of the handle, the escutcheon having an escutcheon surface; and
a polytetrafluoroethylene (PTFE) coating disposed on at least a portion of the handle surface and at least a portion of the escutcheon surface.

2. The anti-ligature door handle assembly of claim 1, wherein the handle and escutcheon are formed such that no portion of a stationary surface is substantially parallel to a ground surface.

3. The anti-ligature door handle assembly of claim 1, wherein upwards facing surfaces are constructed such that surfaces taper away from a surface of a door when the door handle assembly is coupled to a door.

4. The anti-ligature door handle assembly of claim 1, wherein the PTFE coating is approximately 0.75 mm thick.

5. The anti-ligature door handle assembly of claim 1, wherein the PTFE coating is a sintered and skived PTFE coating.

6. The anti-ligature door handle assembly of claim 1, wherein the PTFE coating reflects UV light, and wherein the PTFE coating reflects light in a nearly Lambertian manner.

7. The anti-ligature door handle assembly of claim 1, wherein the PTFE coating has a consistent pore diameter, wherein the pore diameter is in a range of approximately 1-7 micrometers.

8. The anti-ligature door handle assembly of claim 1, wherein the PTFE coating has a coefficient of friction between 0.05 and 0.1.

9. The anti-ligature door handle assembly of claim 1, wherein the PTFE coating has a high omni-directional tensile strength.

10. The anti-ligature door handle assembly of claim 1, wherein the PTFE coating is applied using a spray and cure process.

11. A method of coating an anti-ligature door handle assembly, the method comprising:
sintering polytetrafluoroethylene (PTFE) particles to create a bulk volume of PTFE;
skiving the bulk volume of PTFE to obtain a PTFE sheet of substantially consistent thickness; and
coating an anti-ligature handle with the PTFE sheet.

12. The method of coating the anti-ligature door handle assembly of claim 11, further comprising forming the PTFE sheet into a thickness of approximately 0.75 mm.

13. The method of coating the anti-ligature door handle assembly of claim 11, wherein coating the anti-ligature handle with the PTFE sheet comprises coating the anti-ligature handle with the PTFE sheet capable of reflecting UV light, and wherein coating the anti-ligature handle with the PTFE sheet comprises coating the anti-ligature handle with the PTFE sheet having a reflectivity of light in a nearly Lambertian manner.

14. The method of coating the anti-ligature door handle assembly of claim 11, wherein sintering the PTFE particles to create a bulk volume of PTFE and skiving the bulk volume of PTFE comprises sintering the PTFE particles to create a bulk volume of PTFE and skiving the bulk volume of PTFE to obtain a PTFE sheet having a substantially consistent pore diameter, wherein the pore diameter is in a range of approximately 1-7 micrometers.

15. The method of coating the anti-ligature door handle assembly of claim 11, wherein coating the anti-ligature handle with the PTFE sheet comprises coating the anti-ligature handle with the PTFE sheet having a coefficient of friction between 0.05 and 0.1.

16. The method of coating the anti-ligature door handle assembly of claim 11, wherein sintering the PTFE particles to create a bulk volume of PTFE and skiving the bulk volume of PTFE comprises sintering the PTFE particles to create a bulk volume of PTFE and skiving the bulk volume of PTFE to obtain a PTFE sheet with a high omni-directional tensile strength.

17. A method of coating an anti-ligature door handle assembly, the method comprising:
spraying PTFE onto a desired surface of the anti-ligature door handle assembly;
oven curing the PTFE at a first temperature; and
oven curing the PTFE at a second temperature.

18. The method of coating the anti-ligature door handle assembly of claim 17, wherein coating the anti-ligature handle with PTFE comprises coating the anti-ligature handle with PTFE capable of reflecting UV light, and wherein coating the anti-ligature handle with PTFE comprises coating the anti-ligature handle with PTFE having a reflectivity of light in a nearly Lambertian manner.

19. The method of coating the anti-ligature door handle assembly of claim 17, wherein spraying PTFE onto a desired surface, and curing the PTFE comprises spraying PTFE onto a desired surface and curing PTFE to obtain a PTFE coating having a substantially consistent pore diameter, wherein the pore diameter is in a range of approximately 1-7 micrometers.

20. The method of coating the anti-ligature door handle assembly of claim 17, wherein coating the anti-ligature handle with PTFE comprises coating the anti-ligature handle with PTFE having a coefficient of friction between 0.05 and 0.1.

21. The method of coating the anti-ligature door handle assembly of claim 17, wherein spraying PTFE onto a desired surface, and curing the PTFE comprises spraying PTFE onto a desired surface and curing PTFE to obtain a PTFE coating having a high omni-directional tensile strength.
